(19) United States
(12) Patent Application Publication
(10) Pub. No.: US 2007/0082776 A1
(43) Pub. Date: Apr. 12, 2007

(54) Roller chain

(76) Inventor: Kenichi Nagao, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/504,460

(22) Filed: Aug. 15, 2006

(30) Foreign Application Priority Data
Oct. 12, 2005 (JP) 2005-297554

(51) Int. Cl. F16G 13/02

(52) U.S. Cl. 474/230; 474/231; 474/228

(57) ABSTRACT

A roller chain, in which when the roller chain comes into contact with guide members, the contact area is reduced, so that frictional resistance is decreased and friction loss generated during transmission of power is reduced. A roller chain is formed such that an outer link assembly comprising a pair of outer link plates and an inner link assembly comprising a pair of inner link plates are alternately connected along the pitch line of the chain to each other by pins. The distance from the pitch line of the roller chain to outermost edge surfaces of the link plates is the backside height. The backside height of the outer link plates is lower than the backside height of the inner link plates. When the roller chain contacts and slides on the guide members, the outer link plate does not come into contact with the guide members so that friction loss can be reduced. In some embodiments, some of the link plates are concave ellipsoidal (gourd-shaped) and others are non-concave ellipsoidal (cucumber-shaped).

### FIELD OF INVENTION

The present invention relates to a roller chain used in a timing drive system in an internal-combustion engine such as an automobile engine or the like, and more specifically relates to a roller chain, which can reduce a friction loss due to sliding friction with a guide member such as a tensioner lever, a guide lever or the like.

### BACKGROUND OF THE INVENTION

Recently, as a timing drive chain in an automobile engine, a roller chain has been adopted in place of a toothed belt, which has been often used from the needs of high load, high speed, maintenance-free and the like, such as shown in FIG. 5. (Also see Japanese Laid-Open Patent Publication No. 2004-257531).

When a roller chain is used in a timing drive system in an automobile engine; a timing chain Tc is wrapped around a crank sprocket S1 and cam sprockets S2, S2. This timing chain Tc contact-slides on guide members of a tensioner lever G1, a guide lever and the like, which are adapted to apply appropriate tension. It is noted that the reference mark T denotes a tensioner, E an engine block, B1 a pivot bolt and B2 a securing bolt.

### SUMMARY OF THE INVENTION

A roller chain 31 is formed such that it comprises, as shown in FIGS. 6 to 8, outer links 34 in each of which pins 33 are force-fit into pin holes of a pair of outer link plates 32 and inner links 37 in each of which bushes 36 are force-fit into bush holes 35a of a pair of inner link plates 35, and the outer link 34 and the inner link 37 are alternately connected to each other by loosely inserting pins 33 into the bushes 36. Onto these bushes 36 are rotatably loosely fitted rollers 38.

In the roller chain 31, the outer link plate 32 of the outer link 34 and the inner link plate 35 of the inner link 37 each have an ellipsoidal shape (see FIGS. 7 and 8). The ellipsoidal shape has an outline with semi-circular end portions connected by a mid-portion with outer edges tangential to the semi-circular outline of the end portions. In each link plate 32, 35, when a distance from the chain pitch line P to the outermost edge surface 32b, 35b of each link plate is defined as a backside height, the backside height H7 of the outer link plate 32 and the backside height H7 of the inner link plate 35 are the same.

In a case where the roller chain 31 comes into contact with the guide members of the tensioner lever G1, the guide lever G2 and the like, when the outer link plate 32 and the inner link plate 35 have the same backside height, there is a problem that a friction loss is generated during the transmission of power due to a large contact area and large frictional resistance by the contact of both link plates 32, 35 with the guide members. Particularly, when the roller chain 31 is incorporated into an automobile engine and is used as a timing chain, there is a problem that a large friction loss deteriorates fuel cost.

Accordingly, the object of the present invention is to solve the above-mentioned prior art problems or to provide a roller chain, in which when the roller chain comes into contact with guide members such as a tensioner lever, a guide lever and the like, the contact area can be reduced, so that frictional resistance can be decreased and a friction loss generated during transmission of power can be reduced.

The present invention solves the problems by a configuration that a roller chain comprising outer links in each of which pins are force-fit into pin holes of a pair of outer link plates, and inner links in each of which roller-loosely fitted bushes are force-fit into bush holes of a pair of inner link plates, said roller chain being used in a timing drive system in an internal-combustion engine in which said outer link and said inner link are alternately connected to each other by loosely inserting pins of the outer link into said bushes of the inner link, is characterized in that when a distance from a chain pitch line to an outermost edge surface of the link plate is defined as a backside height, the backside height of said outer link plate is lower than the backside height of said inner link plate.

In every embodiment of the present invention, the outer link is formed of an ellipsoidal link plate and said inner link is also formed of an ellipsoidal link plate having semi-circular end portions connected by a mid-portion. In each case, the mid-portion has a transverse width corresponding to the diameter of the semi-circular end portions with its outer edges tangential to the semi-circular edges of the end portions it connects.

In one embodiment of the roller chain of the present invention, the outer link is formed of a gourd-shaped outer link plate and said inner link is formed of a cucumber-shaped inner link plate. The gourd-shaped link has a mid-portion with concave edges, so that the transverse width of the mid-portion gradually diminishes from the end portions toward the mid-portion's mid-point, whereas the cucumber-shaped link has a mid portion with non-concave edges with a transverse width equal to or greater than the diameter of the semi-circular end portions.

In another embodiment of the roller chain of the present invention, selected ones of the outer links are formed of ellipsoidal outer link plates with non-concave mid-portions, and the remaining outer links are formed of ellipsoidal link plates with concave mid-portions, and the inner link plates are formed of an ellipsoidal inner link plate with non-concave mid-portions.

According to the present invention, when the distance from a chain pitch line to an outermost edge surface of the link plate is defined as a backside height, the backside height of the outer link plate is lower than the backside height of the inner link plate. When the chain comes into contact with guide members of a tensioner lever, a guide lever and the like, outermost edge surfaces of the inner link plates only come into contact with the guide members without the contact of the outer link plates therewith. Thus, the contact area can be reduced and frictional resistance can be decreased so that a friction loss generated during transmission of power can be reduced.

Furthermore, when the outer link is formed of a gourd-shaped outer link plate and the inner link is formed of an cucumber-shaped inner link plate, the distinction between a chain of the present invention and a conventional chain can be easily made and at the same time an incorporation error of the link plate during the manufacture can be prevented. Additionally weight reduction of the chain can be achieved.

Also, when selected said outer links are formed of non-concave ellipsoidal outer link plates and the remaining outer links are formed of concave outer link plates and the inner links are formed of a non-concave ellipsoidal inner link plate, the distinction between a chain of the present invention and a conventional chain is even more easily made.

### BRIEF DESCRIPTION OF THE DRAWINGS

FIG. 1 is a partial perspective view of a roller chain of Example 1 according to the present invention.

FIG. 2 is a partial side view viewed of a roller chain of Example 1 according to the present invention.

FIG. 3 is a partial side view viewed of a roller chain of Example 2 according to the present invention.

FIG. 4 is a partial side view viewed of a roller chain of Example 3 according to the present invention.

FIG. 5 is a schematic view of a timing drive system of an automobile engine.

FIG. 6 is a partial plan view of a conventional roller chain.

FIG. 7 is a partial side view of a conventional roller chain.

FIG. 8(A) is an exploded assembly view of an outer link assembly, and FIG. 8(B) is a perspective view of an inner link assembly.

FIG. 9 is a perspective view of a friction loss measuring test device.

### PREFERRED EMBODIMENTS OF THE INVENTION

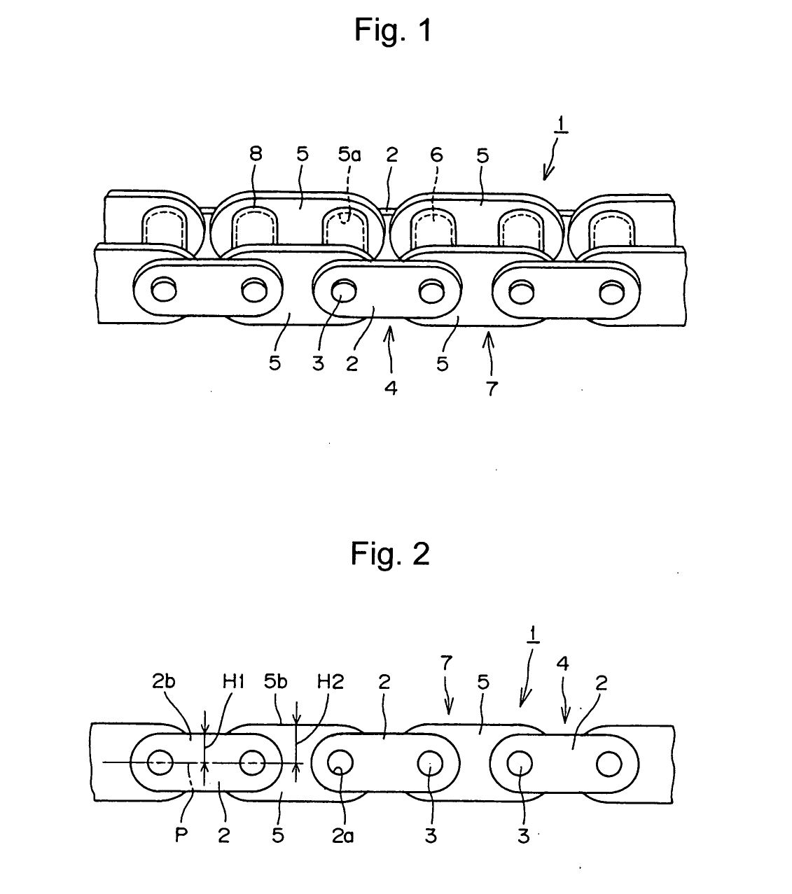

Example 1 of the present invention will be described with reference to FIGS. 1 and 2. FIGS. 1 and 2 are a partial perspective view and a partial side view of a roller chain 1 respectively while showing exaggeratedly that the backside height of an outer link plate is lower than the backside height of an inner link plate.

A roller chain 1 comprises outer link plate assemblies 4 in each of which pins 3 span between and are force-fit into pin holes 2a of a pair of outer link plates 2, and inner link assemblies 7 in each of which bushes 6 span between and are force-fit into bush holes 5a of a pair of inner link plates 5, and a roller 8 is rotatably loosely fitted onto this bush 6. Al of the link plates are ellipsoidal, having semi-circular end portions connected by a mid-portion. The pin holes 2a and bush holes 5a are positioned in the centers of the semi-circular ends portions. The roller chain 1 is flexibly formed such that the outer link assembly 4 and the inner link assembly 7 are alternately connected to each other along the pitch line of the chain by loosely inserting the pins 3 into the bushes 6.

In the roller chain 1, the outer link plate 2 of the outer link assembly 4 and the inner link plate 5 of the inner link assembly 7 are respectively formed in an ellipsoidal shape. Further, when a distance from a pitch line P of the roller chain 1 to an outermost edge surface 2b of the outer link plate 2 is defined as a backside height H1 and a distance from the pitch line P to an outermost edge surface 5b of the inner link plate 5 is defined as a backside height H2, the backside height H1 of the outer link plate 2 is formed to be lower than the backside height H2 of the inner link plate 5. When the roller chain 1 comes into contact with a guide surface of the guide member, only the inner link plate 5 of the chain is brought into contact with the guide member. In this case, since the pin 3 is loosely inserted into the bush, there is a slight clearance between the inner circumferential surface of the bush 6 and the outer circumferential surface of the pin 3. However, in a state of non-clearance that is in a state where an outer edge surface 5b of the inner link plate 5 is strongly brought into contact with the guide member, the outer link plate 2 becomes in a non-contact state with the guide member only by adopting such a construction that a backside height H1 of the outer link plate 2 is formed to be lower by about 0.5 mm than a backside height H2 of the inner link plate 5.

Actions and effects of the roller chain 1 having the above-mentioned construction are as follows. Since the roller chain 1 is formed such that the backside height H1 of the outer link plate 2 is lower than the backside height H2 of the inner link plate 5, when the roller chain 1 comes into contact with the guide members such as the tensioner lever, the guide lever and the like, the outer link plate 2 of the chain does not come into contact with the guide members but only the outermost edge surface 5b of the inner link plate 5 comes into contact therewith. Accordingly, the contact area is reduced and frictional resistance can be decreased. As a result a friction loss generated during transmission of power can be reduced.

Further, a roller chain for a timing drive is generally designed in such a manner that an inner link plate is liable to break as an area, which is broken in the roller chain. In such a roller chain when a backside height of the inner link plate is decreased, the strength of the chain is lowered. However, if the strength of the outer link plate 2 is not lower than the strength of the inner link plate 5, even if the backside height H1 of the outer link plate 2 is formed to be lower than the backside height of the inner link plate 5, an decrease in breaking strength of the roller chain 1 itself can be prevented.

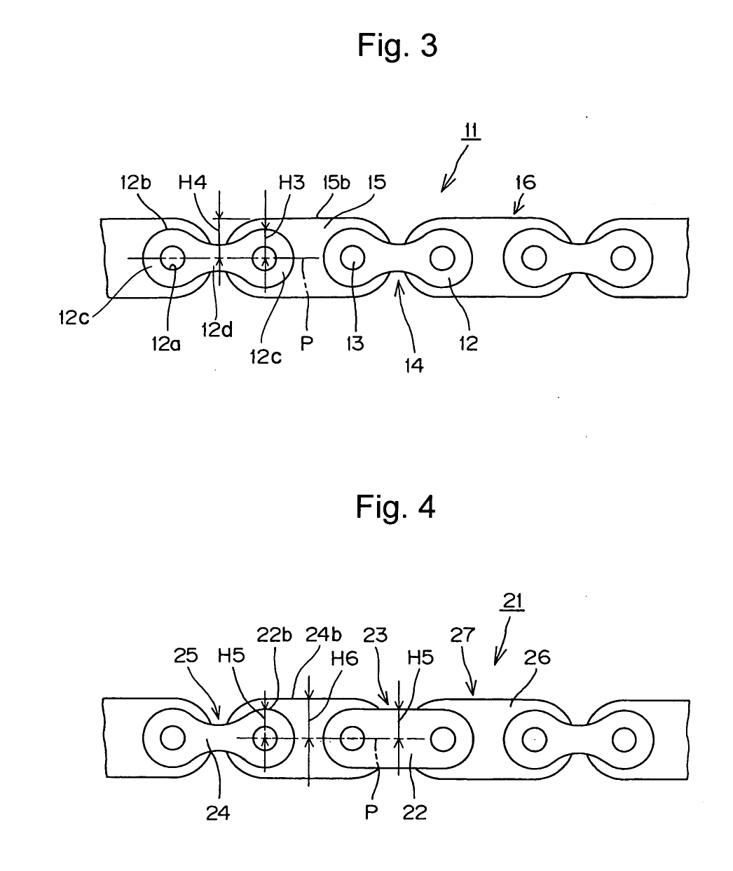

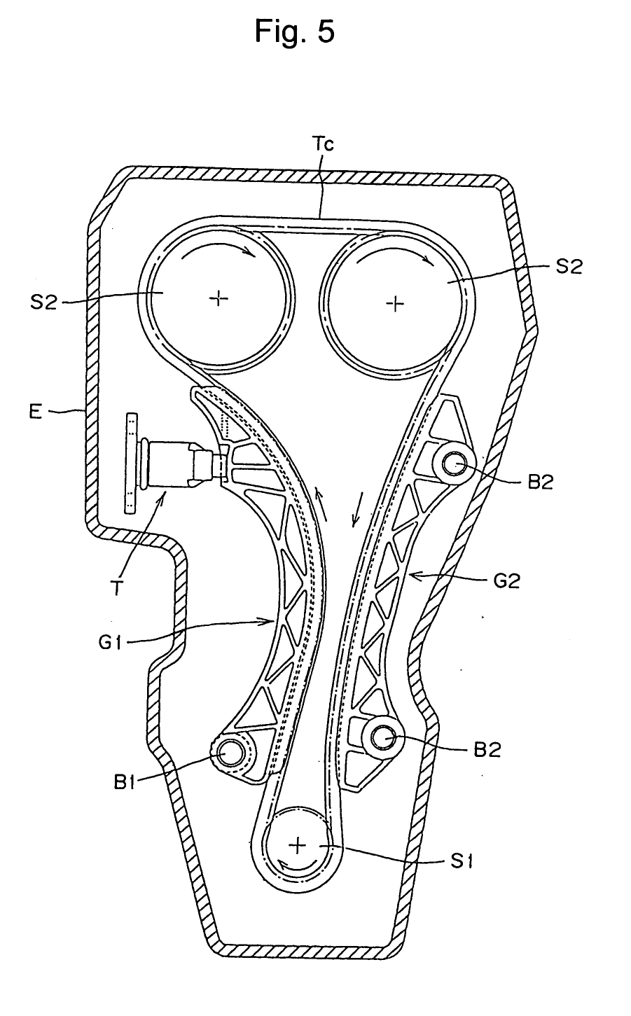

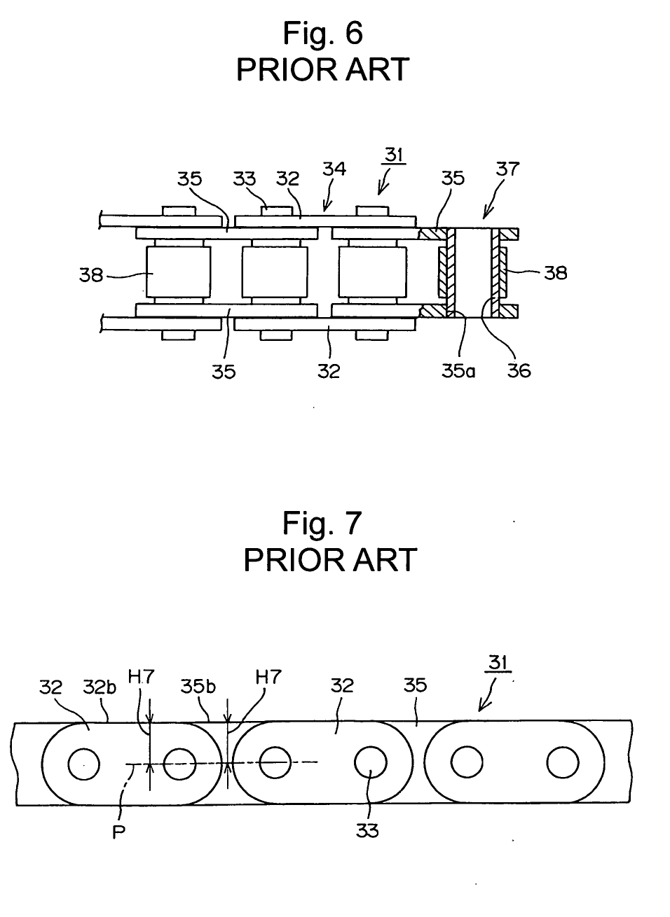

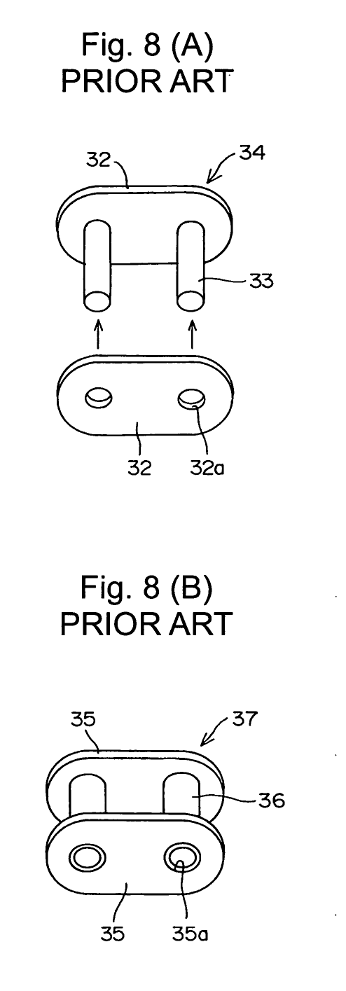

Example 2 of the present invention will be described with reference to FIG. 3. FIG. 3 is a partial side view of a roller chain 11 while showing exaggeratedly that the backside height of an outer link plate is lower than the backside height of an inner link plate. The roller chain 11 of Example 2 corresponds to one using an outer link assembly 14 consisting of gourd-shaped outer link plates 12. The gourd-shaped outer link plates 12 are formed with semi-circular end portions 12c connected by a concave mid-portion 12d.

A roller chain 11 comprises outer link assemblies 14 in each of which pins 13 are force-fit into pin holes 12a of a pair of outer link plates 12, and inner link assemblies 16 in each of which bushes (not shown) are force-fit into bush holes (not shown) of a pair of inner link plates 15, and a roller is rotatably loosely fitted onto this bush. And the roller chain 11 is flexibly formed such that the outer link assembly 14 and the inner link assembly 16 are alternately connected to each other by loosely inserting pins 13 into bushes.

In the roller chain 11, the outer link assembly 14 is formed of concave outer link plates 12 and the inner link assembly 16 is formed of non-concave ellipsoidal inner link plates 15 of the inner link assembly 7 are respectively formed in a non-concave ellipsoidal shape. Further, when a distance from a pitch line P of the roller chain 11 to an outermost edge surface 12b of the outer link plate 12 is defined as a backside height H3 and a distance from the pitch line P to an outermost edge surface 15b of the inner link plate 15 is defined as a backside height H4, the backside height H3 of the outer link plate 12 is formed to be lower than the backside height H4 of the inner link plate 15.

Since the thus formed roller chain 11 is formed such that the backside height H3 of the outer link plate 12 is lower than the backside height H4 of the inner link plate 15, when the roller chain 11 comes into contact with the guide members such as the tensioner lever, the guide lever and the like, the outer link plate 12 of the chain does not come into contact with the guide members but only the outermost edge surface 15b of the inner link plate 15 comes into contact therewith. Accordingly, the contact area is reduced and frictional resistance can be decreased. As a result a friction loss generated during transmission of power can be reduced.

Further, the roller chain 11 is formed such that as in Example 1 the backside height H3 of the outer link plate 12 is lower than the backside height H4 of the inner link plate 15. However, if the strength of the outer link plate 12 is not lower than the strength of the inner link plate 15, a decrease in breaking strength of the roller chain 11 itself can be prevented.

Additionally, since the roller chain 11 is formed such that the outer link assembly 14 comprises gourd-shaped outer link plates 12, the distinction between a chain of the present invention and a conventional chain, formed of ellipsoidal outer link plates, can be easily made and at the same time an incorporation error of the link plates 12, 15 during the manufacture can be prevented. Additionally weight reduction of the chain can be performed.

Example 3 of the present invention will be described with reference to FIG. 4. FIG. 4 is a partial side view of a roller chain 21 while showing exaggeratedly that the backside height of an outer link plate is lower than the backside height of an inner link plate. The roller chain 21 of Example 3 is flexibly formed such that it comprises outer link assemblies 23 each comprising a pair of ellipsoidal outer link plates 22, outer links 25 each comprising a pair of gourd-shaped outer link plates 24, and inner link assemblies 27 each comprising a pair of ellipsoidal inner link plates 26 and the outer link assembly 23, outer link 25 and the inner link assembly 27 are alternately connected to each other. It is noted that the outer link assembly 23 and the outer link 25 may be alternately arranged one by one, or in another sequence.

Further, when a distance from a pitch line P of the roller chain 21 to outermost edge surfaces 22b, 24b of the outer link plates 23, 24 is defined as a backside height H5 and a distance from the pitch line P to an outermost edge surface 26b of the inner link plate 26 is defined as a backside height H6, the backside height H5 of the outer link plates 22, 24 is formed to be lower than the backside height H6 of the inner link plate 26.

Since the thus formed roller chain 21 is formed such that the backside height H5 of the outer link plates 22, 24 is lower than the backside height H6 of the inner link plate 25, when the roller chain 21 comes into contact with the guide members such as the tensioner lever, the guide lever and the like, the outer link plates 22, 24 of the chain does not come into contact with the guide members but only the outermost edge surface 26b of the inner link plate 26 comes into contact therewith. Accordingly, the contact area is reduced and frictional resistance can be decreased. As a result a friction loss generated during transmission of power can be reduced.

Further, the roller chain 21 is formed such that as in Example 1 the backside height H5 of the outer link plates 22, 24 is lower than the backside height H6 of the inner link plate 26. However, if the strength of the outer link plate 12 is not lower than the strength of the inner link plate 15, an decrease in breaking strength of the roller chain 21 itself can be prevented.

Additionally, since the roller chain 21 is formed such that the outer link assembly 23 is formed of non-concave ellipsoidal outer link plates 22, the outer link 25 is formed of concave ellipsoidal outer link plates 24 and the inner link assembly 27 is formed of non-concave ellipsoidal inner link plates 26, the distinction between a chain of the present invention and a conventional chain can be easily made and at the same time an incorporation error of the link plates 22, 24, 25 during the manufacture can be prevented. Additionally weight reduction of the chain can be performed.

The roller chains of Examples 1 to 3 have been described hereinabove. Here test results of friction losses of a roller chain of the present invention and a conventional roller chain will be described below. The tested roller chain of the present invention corresponding to the roller chain of Example 1 and a conventional roller chain have common data of chain pitch; 9.525 mm, outer diameter of roller; 6.35 mm, outer diameter of pin; 3.28 mm, backside height of inner link plate (ellipsoidal); 4.13 mm. A backside height of an outer link plate (ellipsoidal) of the present invention is 3.63 mm, and a backside height of an outer link plate of a conventional example is 4.13 mm.

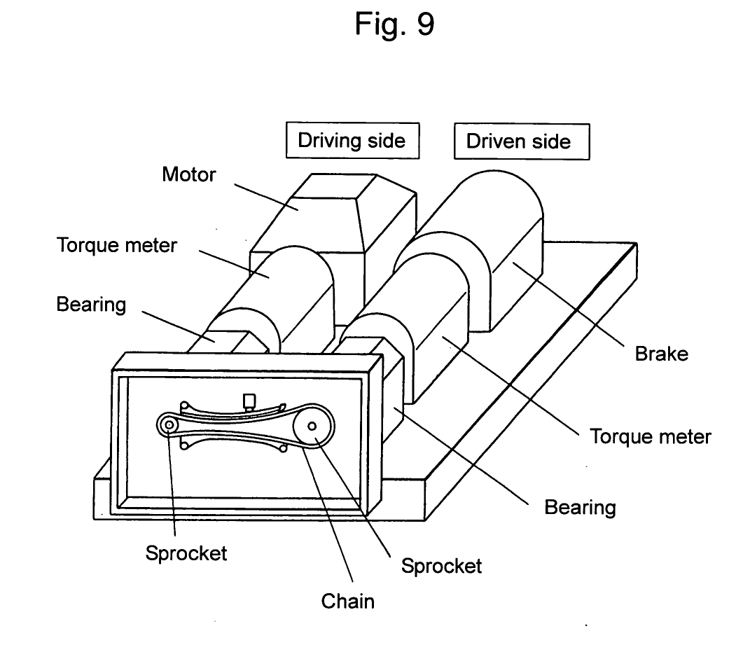

The measurement of friction losses was performed by use of a friction loss measuring test device shown in FIG. 9. In this case a roller chain was wrapped around a driving sprocket with the number of teeth of 30 T and a driven sprocket with the number of teeth of 60 T and was brought into sliding contact with guide members (tensioner lever, guide lever and the like) with a constant pressure. And the roller chain was rotated by a rotation of 600 per min while maintaining tension of 2.0 kN and torques were measured by a driving torque meter and driven torque meter. As a result when a torque difference (N·m) is defined as driving torque−driven torque/2, a torque difference for the roller chain of the present invention was 2.4 N·m, on the other hand, a torque difference for a conventional roller chain was 2.6 N·m. Namely, the roller chain of the present invention can reduce more torque loss due to friction (friction loss) by about 5% than the conventional roller chain.

1. A roller chain comprising outer link assemblies in each of which pins are force-fit into pin holes of a pair of outer link plates, and inner link assemblies in each of which roller-loosely fitted bushes are force-fit to bush holes of a pair of inner link plates, said roller chain being used in a timing drive system in an internal-combustion engine in which said outer link assemblies and said inner link assemblies are alternately connected to each other by loosely inserting pins of the outer link assembly into said bushes of the inner link assembly, characterized in that
when a distance from a chain pitch line to an outermost edge surface of the link plate is defined as a backside height, the backside height of said outer link plate is lower than the backside height of said inner link plate.

2. A roller chain according to claim 1, characterized in that said outer link assembly is formed with an ellipsoidal link plate and said inner link is also formed with an ellipsoidal link plate.

3. A roller chain according to claim 1, characterized in that each said outer link assembly is formed with a gourd-shaped outer link plate and each said inner link assembly is formed with a cucumber-shaped inner link plate.

4. A roller chain according to claim 1, characterized in that selected outer link assemblies are formed with cucumber-shaped outer link plates and the remaining outer link assemblies are formed with gourd-shaped outer link plates and said inner link assemblies are formed with cucumber-shaped inner link plates.

5. A roller chain comprising inner and outer link assemblies interconnected along the chain pitch line of a roller chain adapted for use in a timing drive system in an internal-combustion engine, said outer link assemblies having link plates with pin holes and pins force-fit into said pin holes, and said inner link assemblies having link plates with bush holes and bushes force-fit into said bush holes, said outer link assemblies and said inner link assemblies being alternately connected to each other by said pins of the outer link assemblies being loosely fitted into said bushes of the inner link assemblies, wherein each link assembly has a backside height defined by the distance from said chain pitch line to an outermost edge surface of the link plate, the backside height of said outer link plate being lower than the backside height of said inner link plate.

6. A roller chain according to claim 5, wherein each link plate assembly is formed with an ellipsoidal link plate having semi-circular end portions connected by a mid-portion, each of said pin holes and said bush holes being positioned at the center of one of said semi-circular end portions, said mid-portions having outer edges tangential to the semicircular edges of said end portions.

7. A roller chain according to claim 6, wherein each said outer link plate is formed with a concave mid-portion, and each said inner link plate is formed with a non-concave mid portion.

8. A roller chain according to claim 6, wherein selected outer link plates are formed with non-concave mid-portions, and the remaining outer link plates are formed with concave mid-portions, and said inner link plates are formed with non-concave mid-portions.

9. A roller chain according to claim 8, wherein said selected outer link plates alternate with said remaining outer link plates along the length of the chain.
